(19) United States
(12) Patent Application Publication
(10) Pub. No.: US 2012/0269241 A1
(43) Pub. Date: Oct. 25, 2012

(54) DEVICE AND METHOD OF MAKING A DEVICE

(75) Inventor: Benjamin Pirt, Hertford (GB)

(73) Assignee: ONZO LIMITED, London (GB)

(21) Appl. No.: 13/500,702

(22) PCT Filed: Oct. 11, 2010
(86) PCT No.: PCT/GB2010/051707

§ 371 Date: Jun. 26, 2012

(30) Foreign Application Priority Data
Oct. 9, 2009 (GB) 0917700.7

(51) Int. Cl. H04B 1/38

(52) U.S. Cl. 375/220

(57) ABSTRACT

An Ethernet device able to connect to an Ethernet socket. The Ethernet device comprises a common carrier carrying functional circuitry for at least one function, Ethernet controller circuitry, and contacts for connecting to the Ethernet socket.

### SUMMARY OF THE INVENTION

The present invention relates to functional devices for connection to an Ethernet socket, in particular wireless communication devices, and methods of making the same.

### BACKGROUND

Ethernet is a long-established network technology used to form local area networks (LANs) using Ethernet cables that is simple to install and allows for very high data rates.

As illustrated in FIG. 1, a conventional Ethernet cable 100 comprises a plug 101 formed of plastic or other insulating material carrying a plurality of conductive contacts 102 to which a corresponding plurality of wires (not shown) are attached by crimping to the contacts. Upon insertion into an Ethernet socket a clip (not shown) exerts downward pressure on the plug such that a connection is made between the contacts 102 and corresponding contacts located at the base of the socket. Ethernet cable 103 typically comprises shielded twisted wire pairs in order to exclude noise sources that may otherwise introduce signals into the wires by coupling of electric or magnetic fields.

Ethernet is described in detail in the IEEE 802.3 standard.

FIG. 2 illustrates a prior art arrangement of a router 203 connected via an Ethernet cable 202 to a wireless receiver 201, such as a ZigBee Ethernet gateway or bridge, which receives transmissions from a wireless transmitter such as a ZigBee End Device (ZED, not shown). Router 203 can share this data with any form of network such as a LAN or the internet.

In an alternative arrangement, the wireless receiver 201 may be connected to a computer terminal rather than a router in cases where that data received from the wireless transmitter is to be processed on the computer and/or does not require transmission to a network.

Both the router 203 and the wireless receiver 201 contain a network interface controller (also known as an Ethernet controller, network adapter or LAN adapter) 203a and 201a that comprises the circuitry required to communicate over Ethernet physical and data link layers.

However, use of Ethernet connections between numerous devices, each requiring a power source and Ethernet cabling, can quickly become cumbersome and can create a network with high energy consumption.

It is therefore an object of the invention to simplify networks comprising Ethernet connections.

### SUMMARY OF THE INVENTION

The present inventors have found that many Ethernet-connected devices do not require a large device in order to carry out their essential functions, and that these devices may therefore be integrated with the Ethernet contacts, thereby dispensing with the need for any cables between said devices and the router or computer and also dramatically reducing the size and power requirement of devices connected via Ethernet to a router or computer. Moreover, the absence of cabling means that it is unnecessary to crimp wires to the Ethernet contacts as per conventional Ethernet cabling.

Accordingly, in a first aspect the invention provides an Ethernet device configured to connect to an Ethernet socket and comprising a common carrier carrying functional circuitry for at least one function; Ethernet controller circuitry; and contacts for Ethernet connection.

The common carrier may comprise any material suitable for carrying Ethernet circuitry, functional circuitry and contacts for Ethernet connection. Typically, the common carrier is a single, contiguous board onto which the circuitry and contacts may be printed to form a printed circuit board, however the common carrier may also comprise a plurality of carriers, such as two boards that have been joined together.

Optionally, the common carrier is a printed circuit board.

Optionally, the functional circuitry comprises wireless receiver circuitry. This may be receiver circuitry only or it may be transceiver circuitry.

Optionally, the functional circuitry comprises an integrated circuit configured to demodulate radio signals.

Optionally, the device comprises an antenna.

Optionally, the antenna is detachable from the rest of the device.

Optionally, the functional circuitry configures the device as a ZigBee Ethernet gateway or bridge. In this case, the data rate of the receiver may be less than 1 mbps.

Optionally, the functional circuitry configures the device as a base station for a femtocell.

Optionally, the device further comprises means for connection to a power supply.

In one embodiment, the means for connection to a power supply is a connector configured to be interposed between a power source and a power socket for connecting the power source to another device comprising an Ethernet socket.

In another embodiment, the means for connection to a power supply comprises a USB connector.

Optionally, the power requirement to operate the device is no more than 1 W.

Optionally, the Ethernet controller circuitry comprises a media access controller, a physical layer and a buffer.

Optionally, the part of the common carrier carrying the contacts for Ethernet connection is located within an Ethernet plug.

Optionally, at least part of the part of the common carrier not carrying the contacts for Ethernet connection is located within a housing.

Optionally, the device further comprises locking means configurable to lock the device to another device that the functional device is connected to when in use.

In a second aspect, the invention provides a method of forming an Ethernet device configured to connect to an Ethernet socket, the method comprising application of functional circuitry for at least one function; Ethernet controller circuitry; and contacts for Ethernet connection to a common carrier.

The steps of applying Ethernet circuitry, functional circuitry and contacts for Ethernet connection to the circuit board in accordance with this aspect of the invention may take place in any order.

In a third aspect the invention provides a modular Ethernet device configured to connect to an Ethernet socket and comprising a plurality of connectable modules connected to form a device comprising functional circuitry for at least one function; Ethernet controller circuitry; and contacts for Ethernet connection.

Optionally, the device comprises a first module and a second module.

In one arrangement, the first module comprises the Ethernet controller circuitry and the second module comprises the functional circuitry.

In another arrangement, the first module comprises the Ethernet controller circuitry and at least part of the functional circuitry.

Optionally, the first module comprises at least part of the functional circuitry and the second module comprises the remainder of the functional circuitry.

Optionally, one of the modules comprises an antenna.

### DESCRIPTION OF THE FIGURES

The invention is described in more detail hereinafter with reference to the Figures, wherein:

FIG. 1 illustrates a prior art Ethernet connector and cable;

FIG. 2 illustrates a prior art arrangement of a router with a wired Ethernet gateway or bridge;

FIG. 3 illustrates the printed circuit board of the functional device according to the invention;

FIG. 4 illustrates an Ethernet controller of a functional device according to the invention;

FIG. 5 illustrates a wireless receiver device according to the invention;

FIG. 5B illustrates a further wireless receiver device according to the invention; and

FIG. 6 illustrates a device according to the invention with an interposing jack for power supply.

### DETAILED DESCRIPTION OF THE INVENTION

Referring to FIG. 3, the Ethernet device of the invention comprises a printed circuit board (PCB) 300 carrying a plurality of contacts 301 for connection with corresponding contacts provided within the Ethernet socket; Ethernet controller circuitry 302; and functional circuitry 303. The Ethernet controller circuitry 302 provides the circuitry required for the Ethernet device to communicate with a host device, in particular a computer or a router, over Ethernet physical and data link layers. Separate from this, the functional circuitry 302 comprises the circuitry to provide the functionality of the Ethernet device.

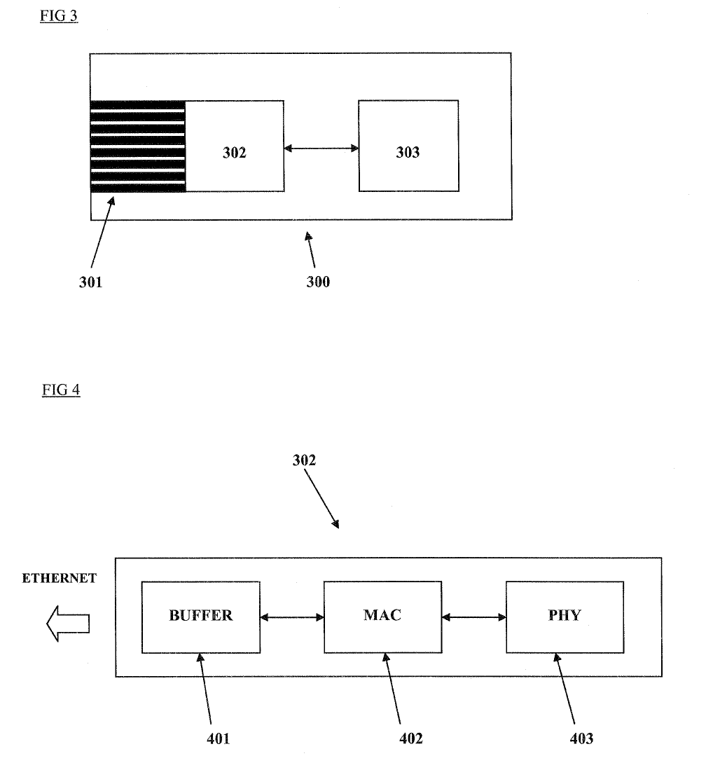

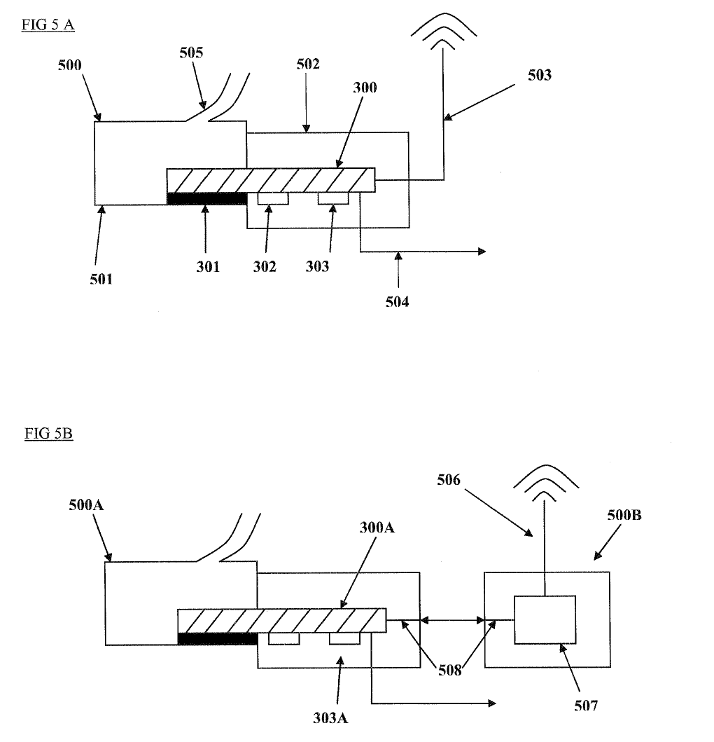

Referring to FIG. 4, the Ethernet controller 302 comprises a Media Access Controller (MAC) 402, a physical layer (PHY) 403 and a transmit/receive buffer 401. Single-chip Ethernet controllers comprising these components are known in the art and are available from, for example, Microchip. In the present invention, Ethernet controllers of this type are provided with, and connected to, a functional device on a common carrier.

The device may be any form of functional device that may be connected via an Ethernet connection, provided that the functional circuitry 303 required to perform the function of the device can be accommodated on the common carrier. The common carrier preferably has a width in the range of up to about 40 mm, up to about 30 mm or up to about 20 mm, and preferably has a length in the range of up to about 100 mm, or up to about 75 mm. In one example the common carrier has a width of about 14 mm and a length of about 60 mm. The required dimensions of the common carrier, that is the width and length of the common carrier, will depend upon what the functions of the functional device are, and how much space is required on the common carrier to accommodate the necessary functional circuitry 303 to allow the functional device to be utilised. In particular, the width of the common carrier must be sufficient to allow the functional device on the carrier to be utilised. Further, it will usually be preferred for the maximum width of the common carrier to be limited so that when the common carrier is located in a port of a multi-port device such as a router, the common carrier does not obscure adjacent ports and prevent their being used. Exemplary devices include wireless receivers, transmitters and transceivers, for example a radio receiver such as a ZigBee Ethernet gateway or bridge; wireless M-BUS; Wi-Fi Ethernet bridge; and receivers, transmitters and transceivers for Bluetooth; WiMax; GSM; GPRS; 3G mobile data access; low-rate wireless personal area networks such as (LR-WPAN); and 6LoWPAN. The transmitters may operate at any suitable frequency, for example 433 MHZ, 868 MHz or 915 MHz. The device may be a base station such as a femtocell, for example an UMTS femtocell or a femtocell for any other applicable standard. The device is not necessarily a receiver and/or transmitter; for instance, the device may be a memory device for data storage.

When the functional device includes a wireless receiver, transmitter or transceiver the hardware of the device 300, and in particular the hardware of the functional circuitry 303, may be designed to be capable of operating at a number of different frequencies so that it is able to support a plurality of different wireless platforms, for example both 433 MHZ and 868 MHz wireless platforms. The device can then be set to operate with a specific platform and frequency, and the hardware populated with suitable software during manufacture.

ZigBee is a low data rate wireless networking standard. IEEE 802.15.4 focuses on the specification of the lower two layers of the protocol (physical and data link layer). Details of the upper layers of the protocol stack (network, transport, session, presentation and application layers) are available from the ZigBee Alliance.

Wi-Fi is described in IEEE standard 802.11 and provides high speed network connections.

Wireless M-BUS (Meter-Bus) is a European standard (EN 13757-4) for the remote reading of utility meters, in particular gas or electricity meters.

Bluetooth is an wireless protocol for exchanging data over short distances between any combination of fixed and mobile devices. Bluetooth specifications are available from the Bluetooth Special Interest Group.

WiMax is based on the IEEE 802.16 standard.

LR-WPAN is described in IEEE standard 802.15.4

The 6LoWPAN specification defines encapsulation and header compression for sending and receiving packets over IEEE 802.15.4 based networks.

A conventional wireless receiver receives encoded information in radio waves and outputs it in digital format as an input to a microcontroller, and does the reverse for transmission. In more detail, a conventional wireless receiver typically comprises an antenna interface for receiving a modulated RF signal from an antenna; mixers for frequency down-converting the received signal and splitting it into in-phase (I) and quadrature (Q) components; an analogue to digital converter (ADC); and a demodulator. In the case of a transceiver, the device further comprises a modulator (typically in the form of a modem) to digitally modulate the signal; a digital-to-analogue converter (DAC); frequency up-converters to up-convert the I and Q components into an RF band according to the relevant transmission standard; and an adder to combine the I and Q components.

Conventional ZigBee Ethernet gateway or bridge devices are large and comprise extensive and high-specification functionality that increases the size, power demand and cost of the device. In contrast, the functional circuitry of the device of the invention may contain only the circuitry needed for the device to carry out a single function, which in this example is to act as a wireless receiver such as a gateway or bridge between a ZigBee end device and a router, and the specifications of the gateway or bridge (e.g. RAM or flash memory) may be set accordingly in order to reduce the size of the device. The power consumption of the device according to the invention is also lower than a typical corresponding prior art device. For instance, a conventional ZigBee Ethernet gateway or bridge typically requires a power source providing in the range of 5-15 W, whereas a device according to the invention functioning only as a receiver typically requires less than 1 W, less than 0.5 W or less than 0.25 W.

Moreover, whereas the conventional data rate for Ethernet is 10 or 100 mbps, many applications such as remote reading of utility consumption only need much lower data rates, such as 256 or 512 kbps.

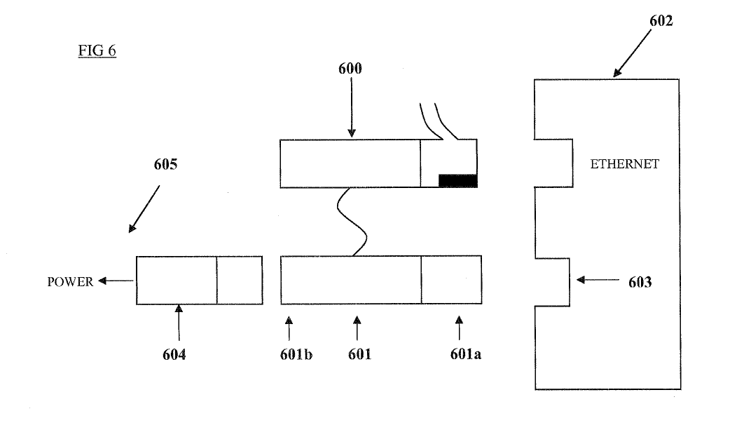

FIG. 5A illustrates a device 500 according to the invention comprising an Ethernet plug 501 containing a first end of PCB 300 carrying contacts 301, a housing 502 carrying the part of the PCB not located within Ethernet plug 501, antenna 503 that may be rotated relative to housing 602, and a power cable 504. Any circuitry required for the antenna may be carried on PCB 300. In this embodiment, the part of the PCB carrying the Ethernet controller circuitry 301 and the functional circuitry 302 protrudes outside the Ethernet plug, however in certain embodiments the part of the PCB carrying the Ethernet controller circuitry and/or the functional circuitry may also be contained within the plug. As with a conventional Ethernet plug, the plug 501 comprises deformable means 505 for applying pressure to the plug when inserted in an Ethernet socket such that the contacts 301 on PCB 300 make contact with corresponding contacts in the socket.

FIG. 5B illustrates a further device according to the invention which has the same structure as the device of FIG. 5A, except that the device is in modular form and comprises modules 500A and 500B that connect together to form the device. Module 500B comprises a detachable antenna 506 that may be detached from the rest of the device. Circuitry associated with the antenna may be provided on chip 507. The modules 500A and 500B may be both physically and electrically connected so that the modules 500A and 500B are in physical contact to form a single physical device. Alternatively, the modules 500A and 500B may only be connected electrically, for example by a cable, so that the module 500B comprising the antenna 506 may be located separately from the module 500A.

In this embodiment, the functional circuitry is formed by connection of functional circuitry 303a provided on PCB 300a and circuitry provided on chip 507. However, in an alternative embodiment the device may comprise a first module carrying the Ethernet circuitry only, and a second module carrying the functional circuitry only.

This modular arrangement allows for the device to be fitted with a range of different antennae by means of a serial connection 508 between the antenna and the rest of the device. By use of a suitable serial connection 508, such as a 4-way jack, the antenna 506 may be rotated relative to the rest of the device while keeping the modules 500A and 500B in close physical contact to form a single physical device.

As discussed above, the functional circuitry 303 comprises an Ethernet device having a buffer memory 401. When the Ethernet device is supporting communications there are a number of communications methodologies which can be used to control the transmission of data from the buffer memory 401. The two main options are that the transmission of data from the buffer memory 401 can be controlled as a push type system or as a pull type system.

If a pull system is used, the pull may, for example, be initiated automatically by an end server or may be initiated manually by a user through a web interface. If a push system is used the puch may be initiated manually by a user through a hardware interface of the host device.

A preferred option is for the functional circuitry to monitor the amount of data held in the buffer memory 401 and to automatically initiate a push of data from the buffer memory 401 if the amount of data held in the buffer memory exceeds a predetermined threshold amount.

Push and pull type data transmission systems are both generally well known, and the skilled person will readily be able to set up and operate systems of either type.

### Power Sources

In the arrangement illustrated in FIG. 5, the functional device is provided with its own discrete power supply in the form of a power cable. However, numerous other arrangements are available, in particular in view of the aforementioned low power requirements of the device.

FIG. 6 illustrates an arrangement wherein the functional device 600 is provided with an interposing connector 601 having jack 601a configured to fit in the power socket 603 of router 602, and socket 601b configured to receive jack 604 of the router power cable 605. When connected, the interposing connector 601 is interposed between the router 602 and the jack 604 of the router power cable 605 connected to the router power supply (not shown). By leeching power from the router power supply in this way, the device does not require connection to a separate power source. One drawback of this arrangement is that the shape of the router power jack 604 and power socket 603 can vary from one router to another depending on the router manufacturer and model, and so it is necessary to ensure that the shape of the intervening jack matches the shape of the router power jack and socket.

Alternatively, the device may be provided with a USB connection, in place of the interposing jack illustrated in FIG. 6, for connection to a USB port of the router through which power may be supplied to the device.

According to a yet further alternative, the device may comprise means for connection to one or more batteries for powering the device. According to a yet further alternative the device may include a battery to power itself.

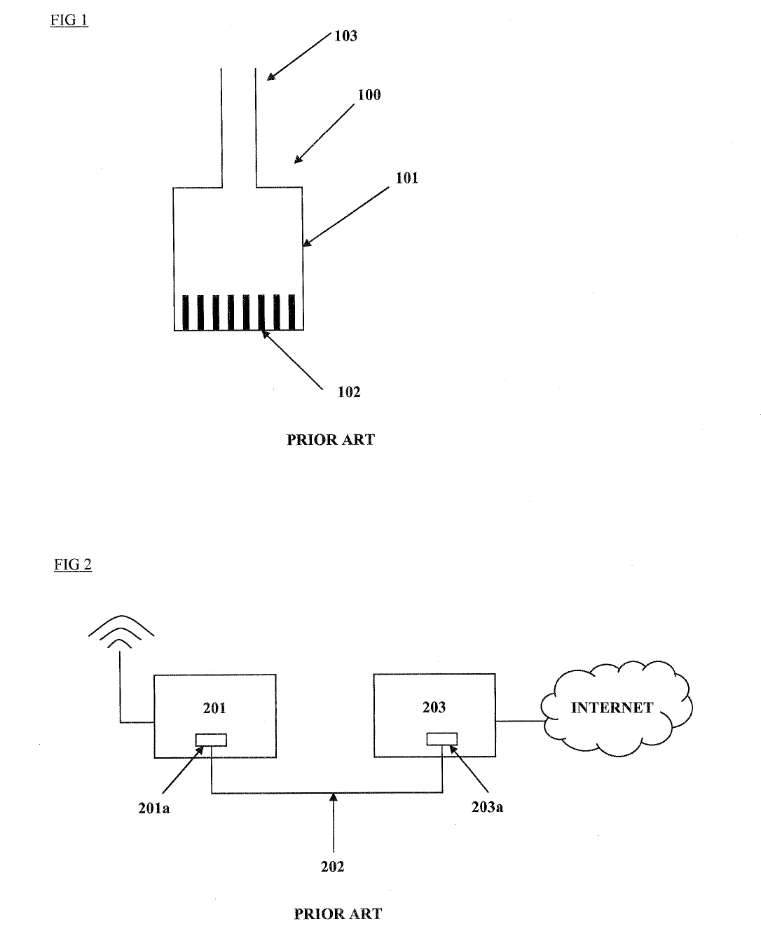

The functional device does not necessarily require separate means for power supply. For example, the device may draw Power over Ethernet (PoE). The IEEE 802.3af standard defines a PoE system in which power is delivered over Ethernet cabling. According to this standard, power is delivered over shielded twisted pair wiring from Power Sourcing Equipment to a Powered Device located at opposite sides of a link. Conventional Ethernet cabling includes four twisted pairs of wires associated with the eight contacts 102 illustrated in FIG. 1. 10Base-T and 100Base-TX Ethernet systems use only two of the twisted wire pairs of transmission of Ethernet data in the differential mode, the remaining two pairs being unused spare pairs. 1000Base-T Ethernet systems use all 4 twisted pairs. Power may be supplied in a common mode between data pairs and/or between spare pairs.

The present invention may utilise PoE as described in the above standard, wherein the device of the invention is the Powered Device and the router to which it is connected comprises Power Sourcing Equipment, with the difference that the twisted wire pairs are not present, the device of the invention being connected as described above via contacts 102 directly to corresponding contacts in the router for data transfer and power.

### Security

A conventional Ethernet connection is fixed in place by means of clip as described with respect to FIG. 1, and the Ethernet jack may simply be removed by pressing down on the clip and withdrawing the jack. This arrangement may be used in order to fix a device according to the invention in place. However, the small size of the device of the invention as compared to conventional Ethernet-connected devices makes it more prone to being lost or stolen. Accordingly, in one arrangement the device is provided with locking means to lock the functional device to the computer, router or other device carrying the Ethernet socket that the functional device is attached to.

The locking means may comprise a wedge that may be retractably inserted under the clip 505 in order to prevent the clip from being pressed down and so stops the device from being removed from the Ethernet port. The wedge may be of any suitable shape and dimensions for insertion under clip 505.

### Applications

It will be appreciated that the device of the invention can be used in a great variety of applications. For instance, in the case where the device of the invention is a ZigBee Ethernet gateway or bridge, the device may be used for gathering of data from one or more wireless transmitters. Data may be collected from one or more ZEDs, for example using a ZigBee mesh network comprising ZEDs, a ZigBee co-ordinator and one or more ZigBee routers for use in monitoring applications, such as monitoring consumption of electricity or other utilities, and in controlling automated systems, for example lighting and heating data, or home entertainment in the case of domestic use, or automated apparatus in a factory. Also, the data collected may relate to persons, for example health or healthcare data.

The device may also be a gateway for mobile telephone network coverage, for example a femtocell for providing wireless network coverage, in particular indoor coverage.

Although the present invention has been described in terms of specific exemplary embodiments, it will be appreciated that various modifications, alterations and/or combinations of features disclosed herein will be apparent to those skilled in the art without departing from the spirit and scope of the invention as set forth in the following claims.

1. An Ethernet device configured to connect to an Ethernet socket and comprising:
a common carrier carrying functional circuitry for at least one function;
Ethernet controller circuitry; and
contacts for Ethernet connection.

2. The Ethernet device according to claim 1 wherein the common carrier is a printed circuit board.

3. The Ethernet device according to claim 1 wherein the functional circuitry comprises wireless receiver circuitry.

4. The Ethernet device according to claim 3 wherein the functional circuitry comprises an integrated circuit configured to demodulate radio signals.

5. The Ethernet device according to claim 3 further comprising an antenna.

6. The Ethernet device according to claim 5 wherein the antenna is detachable from the rest of the device.

7. The Ethernet device according to claim 3 wherein the device is a ZigBee Ethernet gateway or bridge.

8. The Ethernet device according to claim 3 wherein the device is a base station for a femtocell.

9. The Ethernet device according to claim 3 wherein a data rate of the receiver is less than 1 mbps.

10. The Ethernet device according to claim 1 further comprising means for connection to a power supply.

11. The Ethernet device according to claim 10 wherein the means for connection to a power supply is a connector configured to be interposed between a power source and a power socket for connecting the power source to another device comprising an Ethernet socket.

12. The Ethernet device according to claim 10 wherein the means for connection to a power supply comprises a USB connector.

13. The Ethernet device according to claim 10 wherein the power requirement to operate the device is no more than 1 W.

14. The Ethernet device according to claim 1 wherein the Ethernet controller circuitry comprises a media access controller, a physical layer, and a buffer.

15. The Ethernet device according to claim 14 wherein the Ethernet controller circuitry further comprises a buffer monitor adapted to compare the amount of data in the buffer to a threshold and to automatically initiate a push of data from the buffer if the amount of data in the buffer exceeds predetermined threshold.

16. The Ethernet device according to claim 1 wherein a part of the common carrier carrying the contacts for Ethernet connection is located within an Ethernet plug.

17. The Ethernet device according to claim 16 wherein at least part of the part of the common carrier not carrying the contacts for Ethernet connection is located within a housing.

18. The Ethernet device according to claim 1, further comprising locking means configurable to lock the device to another device that the device is connected to when in use.

19. A method of forming an Ethernet device configured to connect to an Ethernet socket, the method comprising:
providing functional circuitry for at least one function;
providing Ethernet controller circuitry; and
providing contacts for Ethernet connection to a common carrier.

20. A modular Ethernet device configured to connect to an Ethernet socket and comprising:
a plurality of connectable modules connected to form a device comprising functional circuitry for at least one function;
Ethernet controller circuitry; and
contacts for Ethernet connection.

21. The modular Ethernet device according to claim 20 further comprising a first module and a second module.

22. The modular Ethernet device according to claim 21 wherein the first module comprises the Ethernet controller circuitry and the second module comprises the functional circuitry.

23. The modular Ethernet device according to claim 21 wherein the first module comprises the Ethernet controller circuitry and at least part of the functional circuitry.

24. The modular Ethernet device according to claim 21 wherein the first module comprises at least part of the functional circuitry and the second module comprises the remainder of the functional circuitry.

25. The modular Ethernet device according to claim 20 wherein one of the modules comprises an antenna.
